(19) United States
(12) Patent Application Publication
(10) Pub. No.: US 2007/0153762 A1
(43) Pub. Date: Jul. 5, 2007

(54) Method of lip synchronizing for wireless audio/video network and apparatus for the same

(75) Inventors: Hee-Yong Park, Suwon-si (KR); Seong-Soo Kim, Seoul (KR); Jae-Kwon Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/605,306

(22) Filed: Nov. 29, 2006

Related U.S. Application Data
(60) Provisional application No. 60/756,221, filed on Jan. 5, 2006.

(30) Foreign Application Priority Data
May 3, 2006 (KR) 10-2006-0040042

(51) Int. Cl. H04J 3/06

(52) U.S. Cl. 370/350

(57) ABSTRACT

Provided is a lip synchronization method in a wireless A/V network. The method includes generating audio and video packets including time stamps and transmitting the audio and video packets to devices in the wireless A/V network, in which the time stamp has information indicating reproduction time points of both audio data included in the audio packet and video data included in the video packet.

### CROSS-REFERENCE TO RELATED APPLICATION

This application claims priority from Korean Patent Application No. 10-2006-0040042 filed on May 3, 2006 in the Korean Intellectual Property Office, and U.S. Provisional Patent Application No. 60/756,221 filed on Jan. 5, 2006 in the United States Patent and Trademark Office, the disclosures of which are incorporated herein by reference in their entirety.

### BACKGROUND OF THE INVENTION

1. Field of the Invention

The present invention relates to lip synchronization, and more particularly, to a lip synchronization method in a wireless audio/video (A/V) network and an apparatus for the same.

2. Description of the Prior Art

With the development of home network technology and an increase in the spread of multimedia contents, demand for a home A/V system is increasing. A home A/V system includes a source device for providing video and audio data, a display device for outputting the video data provided by the source device, and a sound output device for outputting the audio data, separately from the display device.

In such a case, since devices outputting the audio and video data are different, it may be possible that the output time points of the audio and video data do not coincide with each other. Therefore, it is necessary to perform an operation for synchronizing the audio and video data. Conventionally, a user has manually delayed the output time point of the audio data by using a delay button provided to a sound output device or a remote controller. The reason for delaying the output time point of the audio data is because the audio data generally has a shorter processing time than that of the video data.

According to the prior art as described above, in order to synchronize the output time points of audio and video data reproduced through different devices, a home A/V system requires a user's active involvement. On account of this, it is necessary to provide more simple lip synchronization technology.

### SUMMARY OF THE INVENTION

Accordingly, the present invention has been made to address the above-mentioned problems occurring in the prior art, and it is an aspect of the present invention to synchronize audio and video data reproduced through different devices in a wireless A/V network.

The present invention is not limited to the aspect stated above. Those of ordinary skill in the art will clearly recognize additional aspects in view of the following description of the present invention.

In accordance with one aspect of the present invention, there is provided a lip synchronization method in a wireless A/V network, the method including generating audio and video packets having time stamps, and transmitting the audio and video packets to devices in the wireless A/V network, in which the time stamp has information indicating reproduction time points of both audio data included in the audio packet and video data included in the video packet.

In accordance with another aspect of the present invention, there is provided a lip synchronization method in a wireless A/V network, the method including receiving an audio packet, extracting both audio data and a time stamp indicating an output time point of the audio data from the audio packet, and outputting the audio data at the time point indicated by the time stamp.

In accordance with another aspect of the present invention, there is provided a lip synchronization method in a wireless A/V network, the method including receiving a video packet, extracting both video data and a time stamp indicating an output time point of the video data from the video packet, and outputting the video data at the time point indicated by the time stamp.

In accordance with still another aspect of the present invention, there is provided a source device including a packet-processing unit generating audio and video packets including time stamp, and a wireless communication unit transmitting the audio and video packets to devices in a wireless A/V network, in which the time stamp has information indicating reproduction time points of both audio data included in the audio packet and video data included in the video packet.

In accordance with yet another aspect of the present invention, there is provided an audio reproduction device including a wireless communication unit receiving an audio packet, a packet-processing unit extracting both audio data and a time stamp indicating an output time point of the audio data from the audio packet, and a control unit outputting the audio data at the time point indicated by the time stamp.

In accordance with yet another aspect of the present invention, there is provided a video reproduction device including a wireless communication unit receiving a video packet, a packet-processing unit extracting both video data and a time stamp indicating an output time point of the video data from the video packet, and a control unit outputting the video data at the time point indicated by the time stamp.

### BRIEF DESCRIPTION OF THE DRAWINGS

The above and other features and advantages of the present invention will be more apparent from the following detailed description taken in conjunction with the accompanying drawings, in which:

FIG. 1 is a block diagram illustrating a wireless A/V network according to one embodiment of the present invention;

FIG. 2 is a diagram illustrating one example of a beacon frame;

FIG. 3 is a flow diagram illustrating an operation process of a source device according to one embodiment of the present invention;

FIG. 4 is a diagram illustrating audio and video packets according to one embodiment of the present invention;

FIG. 5 is a flow diagram illustrating an operation process of an audio reproduction device according to one embodiment of the present invention;

FIG. 6 is a flow diagram illustrating an operation process of a video reproduction device according to one embodiment of the present invention;

FIG. 7 is a block diagram illustrating a source device according to one embodiment of the present invention;

FIG. 8 is a block diagram illustrating an audio reproduction device according to one embodiment of the present invention; and

FIG. 9 is a block diagram illustrating a video reproduction device according to one embodiment of the present invention.

### DETAILED DESCRIPTION OF EXEMPLARY EMBODIMENTS

Detailed particulars of exemplary embodiments of the invention are included in the detailed description and drawings.

Advantages and features of the present invention, and ways to achieve them will be apparent from embodiments of the present invention as will be described below together with the accompanying drawings. However, the scope of the present invention is not limited to such embodiments and the present invention may be realized in various forms. The embodiments described below are merely provided for a comprehensive understanding of the present invention. The present invention is defined only by the scope of the appended claims. Also, the same reference numerals are used to designate the same elements throughout the specification.

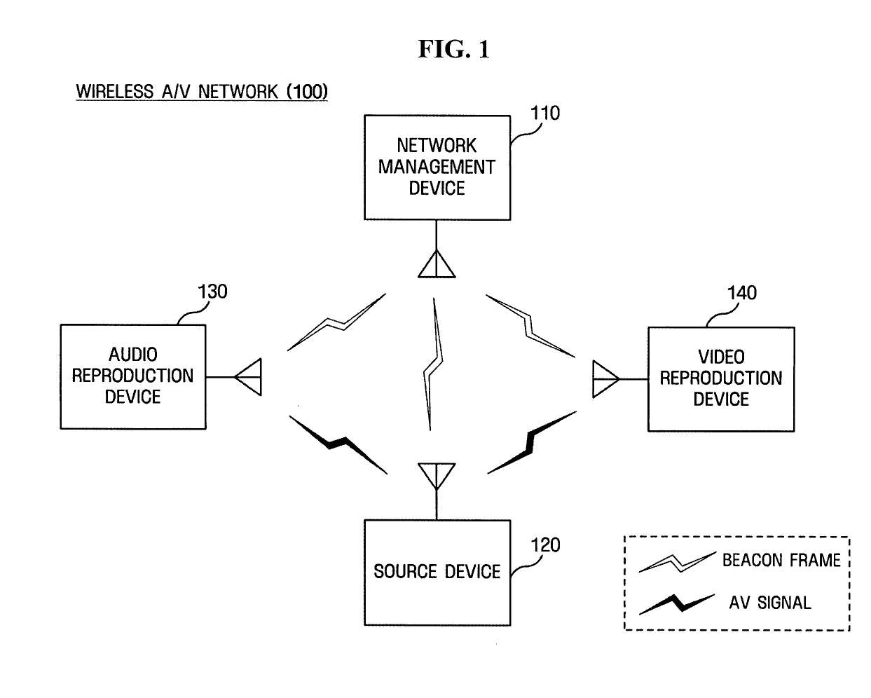

FIG. 1 is a block diagram illustrating a wireless A/V network 100 according to one embodiment of the present invention. The wireless A/V network 100 as illustrated in FIG. 1 includes a network management device 110, a source device 120, an audio reproduction device 130 and a video reproduction device 140.

The network management device 110 is a wireless communication device capable of managing whether devices join or withdraw from the wireless A/V network 100, and of transmitting/receiving data in a wireless manner. The network management device 110 may be realized in various types of devices depending on network standards for constructing the wireless A/V network 100. For example, if the wireless A/V network 100 is constructed based on standards of an IEEE 802.11 series, the network management device 110 may be realized as an Access Point (AP) defined in an IEEE 802.11 standard. Also, if the wireless A/V network 100 is constructed based on an IEEE 802.15.3 standard, the network management device 110 may be realized as a Piconet Coordinator (PNC) defined in an IEEE 802.15.3 standard.

The network management device 110 broadcasts information about both time intervals, for which the devices 120, 130 and 140 participating in the wireless A/N network 100 can occupy wireless channels, and methods by which the devices 120, 130 and 140 occupy the wireless channels in each time interval. A beacon frame, which is a kind of a management frame, may be used in order to transmit such information.

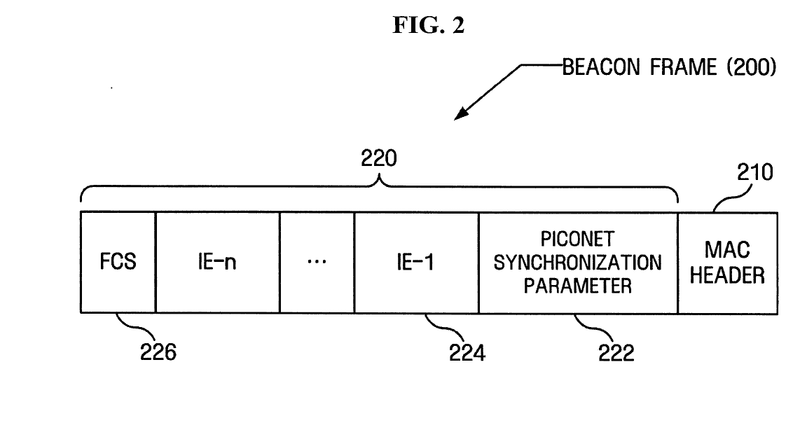

FIG. 2 is a diagram illustrating a beacon frame defined in an IEEE 802.15.3 standard according to one embodiment of the present invention. The beacon frame 200 includes an MAC header 210 and a beacon frame body 220. The beacon frame body 220 includes a piconet synchronization parameter 222 having synchronization information, one or more Information Elements (IEs) 224 having information for notifying the current state of a network of devices within the network, and a frame check sequence 226. The IE 224 may include various types of IEs such as a channel time allocation IE, a Beacon Source Identifier IE (BSID IE), and a device association IE. The channel time allocation IE includes information about allocation of a time zone for which the devices within the network can occupy channels, the BSID IE includes information for identifying the current network from different adjacent networks, and the device association IE includes information for announcing a device, which newly participates in or withdraws from a network, to other devices.

The devices 120, 130 and 140 can occupy channels for predetermined time periods and transmit data according to the information included in the beacon frame 200. Since the devices 120, 130 and 140 are synchronized with one another through the beacon frame 200, they can precisely use the channel occupation time zone understood through the channel time allocation IE included in the beacon frame 200.

It is preferred that such a beacon frame is periodically transmitted, and thus the devices 120, 130 and 140 can become aware of the transmission time point of the beacon frame. Even when the beacon frame is not periodically transmitted, the devices 120, 130 and 140 can become aware of the transmission time point of the beacon frame because the beacon frame generally includes information about the subsequent transmission time point of the beacon frame. Accordingly, the devices 120, 130 and 140 can be temporally synchronized through the beacon frame.

The source device 120 is a wireless communication device wirelessly providing A/V data, which may be realized as a set-top box, a Personal Video Record (PVR), a personal computer, etc. The A/V data provided by the source device 120 may also be in a compressed state or an uncompressed state depending on embodiments.

The A/V data is provided in the form of multiple audio and video packets, and the source device 120 adds a time stamp to each of the audio and video packets. The time stamp is time information indicating the reproduction time points of audio and video data. Accordingly, the same time stamp is added to the audio and video packets respectively including audio and video data having corresponding reproduction time points.

The audio reproduction device 130 separates an audio packet from radio signals transmitted from the source device 120, and reproduces audio data included in the audio packet. The audio reproduction device 130 can adjust the output time of the audio data through the time stamp added to the audio packet.

The video reproduction device 140 separates a video packet from radio signals transmitted from the source device 120, and reproduces video data included in the video packet. The video reproduction device 140 can adjust the output time of the video data through the time stamp added to the video packet.

Since the source device 120, the audio reproduction device 130 and the video reproduction device 140 are temporally synchronized through the beacon frame transmitted from the network management device 110, the video and audio data reproduced by different devices can be synchronized with one another by using the time stamp.

The audio reproduction device 130 and the video reproduction device 140 are wireless communication devices capable of receiving radio signals outputted from the source device 120. The audio reproduction device 130 may be realized as an AV receiver and the video reproduction device 140 may be realized as a digital TV, a projector, a monitor, etc. Of course, the video reproduction device 140 may also reproduce audio data (e.g. when the video reproduction device 140 is a digital TV) and the audio reproduction device 130 may also reproduce video data. However, since the present invention puts emphasis on synchronizing audio and video data reproduced by different devices, a case in which the audio reproduction device 130 reproduces audio data and the video reproduction device 140 reproduces video data will be described hereinafter.

Further, although there is no special mention, the following description will be given on an assumption that the source device 120, the audio reproduction device 130 and the video reproduction device 140 have been temporally synchronized through the beacon frame periodically or non-periodically transmitted from the network management device 110.

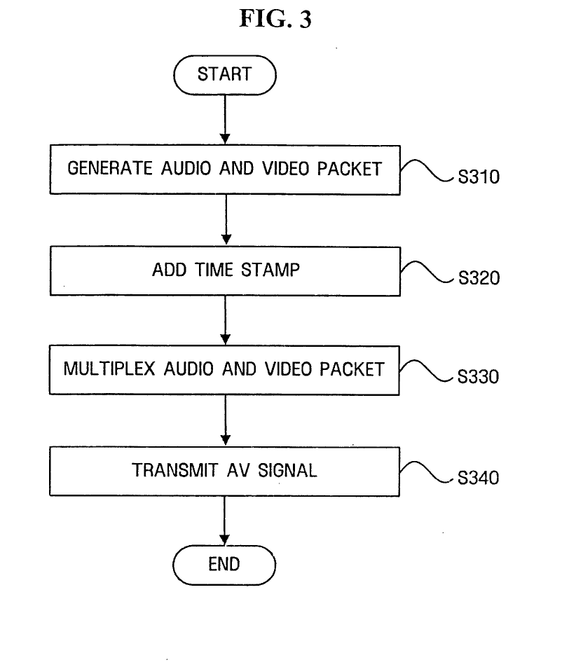

FIG. 3 is a flow diagram illustrating an operation process of the source device 120 according to one embodiment of the present invention.

The source device 120 generates an audio packet including audio data and a video packet including video data (S310). The audio and video data may be in a compressed state by a predetermined compression scheme. For example, the video data may be in a compressed state according to a video compression scheme including a Moving Picture Experts Group (MPEG)-2, an MPEG-4, etc., and the audio data may be in a compressed state according to an audio compression scheme including an MPEG layer-3 (MP3), an Audio Compression 3 (AC3), etc. Not illustrated in FIG. 3, it may be possible to add a process by which the source device 120 compresses the audio and video data by using a predetermined compression scheme. Further, the following process may also be performed while the audio and video data are not in a compressed state depending on embodiments.

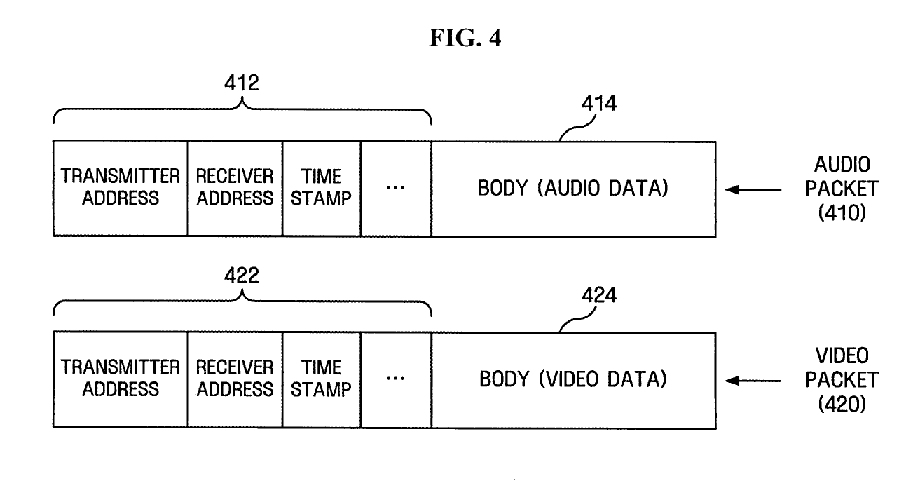

The source device 120 adds time stamps to the audio and video packets, respectively. (S320). Each of the audio and video packets includes both a header area having information about the packet and a body area having audio or video data. As illustrated in FIG. 4, the time stamp may be included both in the header area 412 of the audio packet 410 and the header area 422 of the video packet 420, respectively. However, the present invention is not limited to this example. That is, the time stamp may also be included both in the body area 414 of the audio packet 410 and the body area 424 of the video packet 420, respectively.

As described above, the time stamp includes information indicating the reproduction time points of the audio and video data. For example, the time stamp may also have a form of time information (e.g. after time t passes from a reception time point of an nth beacon) employing a reception time point of a beacon as a reference, or absolute time information (e.g., hour-minute-second) which can be understood by timers separately provided to the devices 120, 130 and 140. Herein, the source device 120 adds the same time stamps to the audio and video packets respectively including the audio and video data to be outputted in the same time zone.

Then, the source device 120 multiplexes the audio and video packets (S330), and transmits radio signals (hereinafter, referred to as AV signals) including an AV stream generated by multiplexing the packets to the audio reproduction device 130 and the video reproduction device 140 (S340).

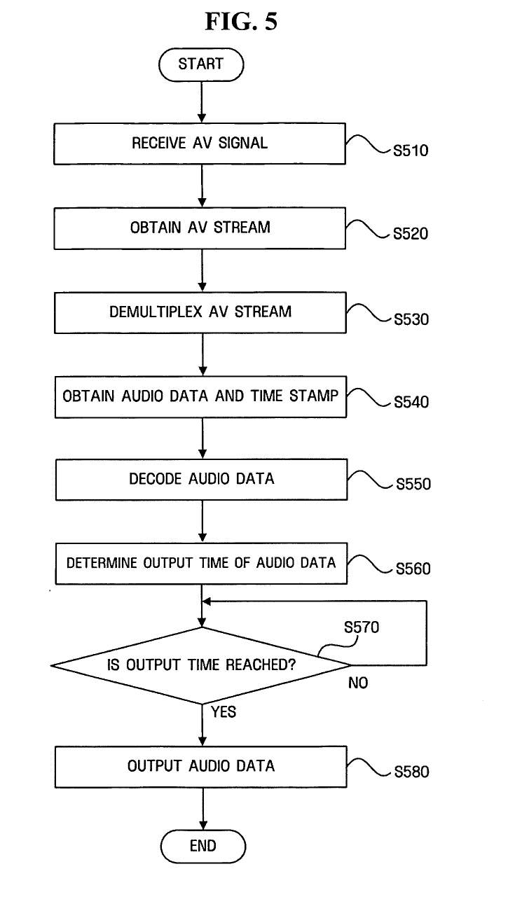

FIG. 5 is a flow diagram illustrating an operation process of the audio reproduction device 130 according to one embodiment of the present invention.

If AV signals outputted from the source device 120 are received (S510), the audio reproduction device 130 restores the received AV signals to obtain an AV stream (S520). The audio reproduction device 130 demultiplexes the AV stream (S530), and extracts audio data and a time stamp from an audio packet extracted from the demultiplexed AV stream (S540).

Then, the audio reproduction device 130 decodes the audio data (S550), which may use an audio compression release scheme including an MP3, an AC3, etc. Of course, if the audio data is in an uncompressed state, step 550 may be omitted.

Then, the audio reproduction device 130 determines the output time of the audio data by using a time stamp (S560). If the output time is reached (S570), the audio reproduction device 130 outputs the audio data through a speaker or a woofer (S580).

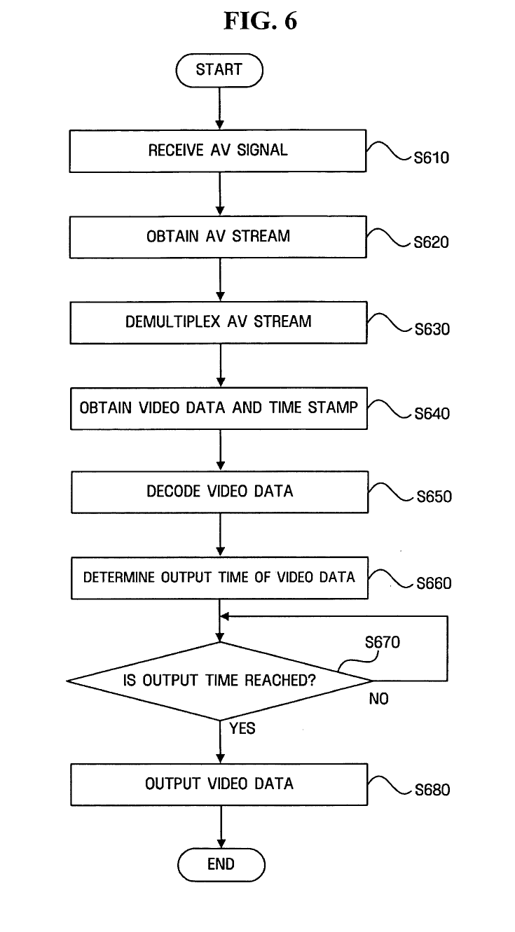

FIG. 6 is a flow diagram illustrating an operation process of the video reproduction device 140 according to one embodiment of the present invention.

If AV signals outputted from the source device 120 are received (S610), the video reproduction device 140 restores the received AV signals to obtain an AV stream (S620). The video reproduction device 140 demultiplexes the AV stream (S630), and extracts video data and a time stamp from a video packet extracted from the demultiplexed AV stream (S640).

Then, the video reproduction device 140 decodes the video data (S650), which may use a video compression release scheme including an MPEG-2, MPEG-4, etc. Of course, if the video data is in an uncompressed state, step 650 may be omitted.

Then, the video reproduction device 140 determines the output time of the video data by using a time stamp (S660). If the output time is reached (S670), the video reproduction device 140 outputs the video data to a predetermined display (S680).

Hereinafter, the construction of the source device 120, the audio reproduction device 130 and the video reproduction device 140 as described above will be described.

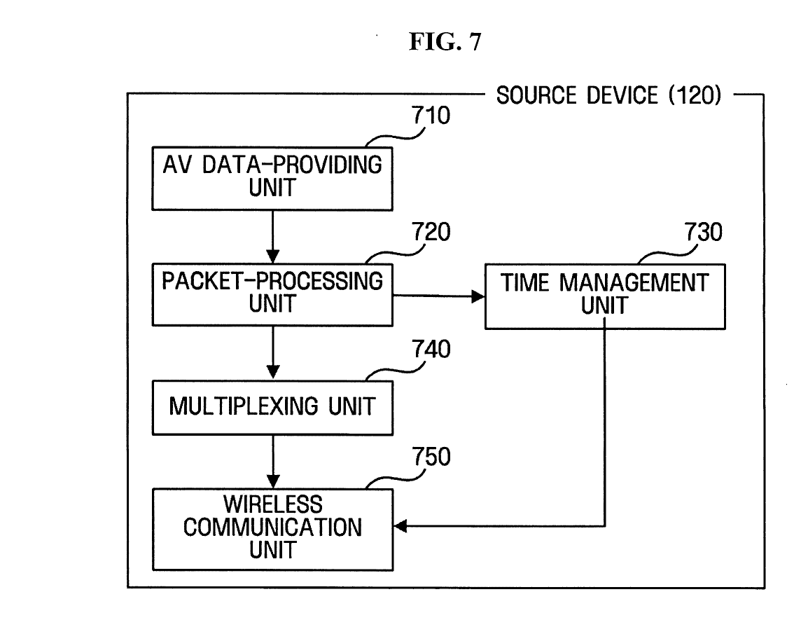

FIG. 7 is a block diagram illustrating the source device 120 according to one embodiment of the present invention. The source device 120 includes an AV data-providing unit 710, a packet-processing unit 720, a time management unit 730, a multiplexing unit 740 and a wireless communication unit 750.

The AV data-providing unit 710 provides audio and video data. If the source device 120 is a set-top box, the audio and video data provided by the AV data-providing unit 710 may include data extracted from broadcasting signals. If the source device 120 is a PVR, the audio and video data provided by the AV data-providing unit 710 may include data previously stored in a storage medium. Further, the audio and video data provided by the AV data-providing unit 710 may also be in a compressed state or an uncompressed state. The compression or uncompression of the data may be selected depending on embodiments of the source device 120. If it is necessary to provide audio and video data in a compressed state, the AV data-providing unit 710 may also include an audio-encoding unit (not shown) for compressing audio data and a video-encoding unit (not shown) for compressing video data.

The packet-processing unit 720 segments the audio and video data provided by the AV data-providing unit 710 into data of a predetermined size, and generates audio and video packets respectively including the segmented audio and video data. Herein, the packet-processing unit 720 adds time stamps to the audio and video packets, respectively. As described above, since the time stamp is time information indicating the reproduction time points of the audio and video data, the same time stamp is added to audio and video packets respectively including audio and video data that must be reproduced in the same time zone. Herein, audio and video packets generally include a sequence number representing an order of packets, respectively. Accordingly, when the same device processes the audio and video packets to reproduce audio and video data, a synchronization problem does not occur between the audio and video data. However, when different devices process the audio and video packets, a sequence number becomes useless when synchronizing audio and video data. For this situation, a time stamp may be used. In order to add a time stamp, the packet-processing unit 720 may receive predetermined time information from the time management unit 730.

The time management unit 730 manages various types of time information necessary for the channel occupation time point, operation timing, etc., of the source device 120. To this end, the time management unit 730 may include a predetermined timer. The time management unit 730 can synchronize the timer through a beacon frame received from the network management device 110, and check the channel occupation period of the source device 120. The time management unit 730 controls the wireless communication unit 750 so that AV data can be transmitted during the channel occupation period checked through the beacon frame.

The multiplexing unit 740 multiplexes the audio and video packets provided by the packet-processing unit 720 to generate an AV stream.

The wireless communication unit 750 converts the AV stream provided by the multiplexing unit 740 into radio signals through a predetermined modulation operation, and outputs the radio signals to the air. Herein, the outputted radio signals correspond to the AV signals as described above. Further, the wireless communication unit 750 receives the beacon frame transmitted from the network management device 110, and transfers the received beacon frame to the time management unit 730.

The wireless communication unit 750 may include a baseband processor (not shown) for processing baseband signals, and a Radio Frequency (RF) processor (not shown) for actually generating radio signals from the processed baseband signals and transmitting the generated radio signals to the air through an antenna. In more detail, the baseband processor performs frame formatting, channel coding, etc., and the RF processor performs operations including analog wave amplification, analog/digital signal conversion, modulation, etc.

An operation process between elements of the source device 120 described with reference to FIG. 7 will be understood in conjunction with the flow diagram of FIG. 3.

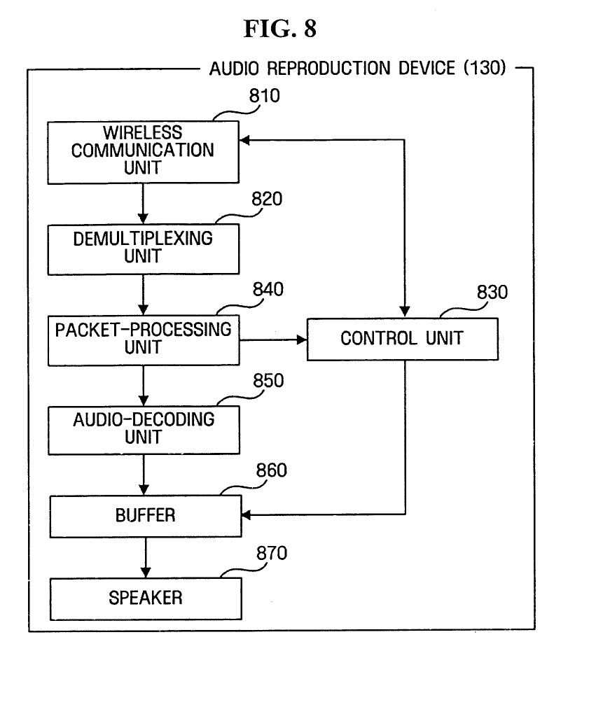

FIG. 8 is a block diagram illustrating the audio reproduction device 130 according to one embodiment of the present invention. The audio reproduction device 130 includes a wireless communication unit 810, a demultiplexing unit 820, a control unit 830, a packet-processing unit 840, an audio-decoding unit 850, a buffer 860 and a speaker 870.

The wireless communication unit 810 receives the beacon frame transmitted from the network management device 110, and provides the received beacon frame to the control unit 830. The wireless communication unit 810 receives the AV signals transmitted from the source device 120, and demodulates the received AV signals to obtain an AV stream. The AV stream is transferred to the demultiplexing unit 820. Since the wireless communication unit 810 for performing such operations has the basic structure similar to that of the wireless communication unit 750 of the source device 120, details will be omitted.

The demultiplexing unit 820 demultiplexes the AV stream transferred from the wireless communication unit 810 to obtain an audio packet. Of course, the demultiplexing unit 820 can also obtain a video packet from the AV stream, but it is not necessary to discuss this for the present embodiment.

The packet-processing unit 840 extracts audio data and a time stamp from the audio packet obtained by the demultiplexing unit 820. The extracted audio data is transferred to the audio-decoding unit 850 and the extracted time stamp is transferred to the control unit 830.

The audio-decoding unit 850 decodes the audio data provided by the packet-processing unit 840. To this end, the audio-decoding unit 850 may use an audio compression release scheme including an MP3, an AC3, etc. If the source device 120 uses audio data in an uncompressed state, the audio reproduction device 130 may not include the audio-decoding unit 850.

The buffer 860 stores audio data provided through the audio decoding operation of the audio-decoding unit 850. The audio data is temporarily stored in the buffer 860, and outputted through the speaker 870 under the control of the control unit 830.

The control unit 830 manages various types of time information necessary for the channel occupation time point, operation timing, etc., of the audio reproduction device 130. To this end, the control unit 830 may include a predetermined timer. The control unit 830 synchronizes the timer through the beacon frame received from the network management device 110.

Further, the control unit 830 outputs the audio data temporarily stored in the buffer 860 to the speaker 870. In order to determine the output time point of the audio data, the control unit 830 may use the time stamp provided by the packet-processing unit 840. The output time point of the audio data indicated by the time stamp has been set by the network management device 110 using its own timer. However, since the network management device 110 is temporally synchronized with the audio reproduction device 130 through the beacon frame, the control unit 830 can output the audio data to the speaker 870 at a proper time point.

An operation process between elements of the audio reproduction device 130 described with reference to FIG. 8 will be understood in conjunction with the flow diagram of FIG. 5.

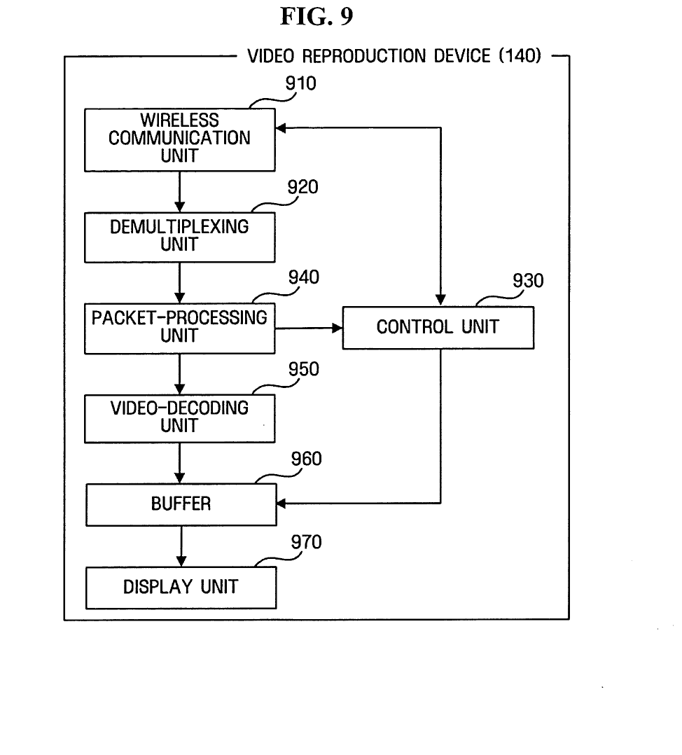

FIG. 9 is a block diagram illustrating the video reproduction device 140 according to one embodiment of the present invention. The video reproduction device 140 includes a wireless communication unit 910, a demultiplexing unit 920, a control unit 930, a packet-processing unit 940, a video-decoding unit 950, a buffer 960 and a display unit 970.

The wireless communication unit 910 receives the beacon frame transmitted from the network management device 110, and provides the received beacon frame to the control unit 930. The wireless communication unit 910 receives the AV signals transmitted from the source device 120, and demodulates the received AV signals to obtain an AV stream. The AV stream is transferred to the demultiplexing unit 920. Since the wireless communication unit 910 for performing such operations has the basic structure similar to that of the wireless communication unit 750 of the source device 120, details will be omitted.

The demultiplexing unit 920 demultiplexes the AV stream transferred from the wireless communication unit 910 to obtain a video packet. Of course, the demultiplexing unit 920 can obtain an audio packet from the AV stream, but this is not an object of concern in the present embodiment.

The packet-processing unit 940 extracts video data and a time stamp from the video packet obtained by the demultiplexing unit 920. The extracted video data is transferred to the video-decoding unit 950 and the extracted time stamp is transferred to the control unit 930.

The video-decoding unit 950 decodes the video data provided by the packet-processing unit 940. To this end, the video-decoding unit 950 may use a video compression release scheme including an MPEG-2, an MPEG-4, etc. If the source device 120 uses video data in an uncompressed state, the video reproduction device 140 may not include the video-decoding unit 950.

The buffer 960 stores video data provided through the video decoding operation of the video-decoding unit 950. The video data is temporarily stored in the buffer 960, and outputted through the display unit 970 under the control of the control unit 930.

The control unit 930 manages various types of time information necessary for the channel occupation time point, operation timing, etc., of the video reproduction device 140. To this end, the control unit 930 may include a predetermined timer. The control unit 930 synchronizes the timer through the beacon frame received from the network management device 110.

Further, the control unit 930 outputs the video data temporarily stored in the buffer 960 to the display unit 970. In order to determine the output time point of the video data, the control unit 930 may use the time stamp provided by the packet-processing unit 940. The output time point of the video data indicated by the time stamp has been set by the network management device 110 using its own timer. However, since the network management device 110 is temporally synchronized with the video reproduction device 140 through the beacon frame, the control unit 930 can output the video data to the display unit 970 at a proper time point.

An operation process between elements of the video reproduction device 140 described with reference to FIG. 9 will be understood in conjunction with the flow diagram of FIG. 6.

The term “unit”, as used for indicating the elements of the source device 120, the audio reproduction device 130 and the video reproduction device 140 herein, may be realized as a kind of “module”. The module means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

Although exemplary embodiments of the present invention has been described for illustrative purposes, those skilled in the art will appreciate that various modifications, additions and substitutions are possible, without departing from the scope and spirit of the invention as disclosed in the accompanying claims.

According to a lip synchronization method in a wireless AN network and an apparatus for the same as described above, it is possible to automatically synchronize audio and video data reproduced by different devices in the wireless A/V network.

What is claimed is:

1. A synchronization method in a wireless network, the method comprising:
generating audio and video packets including time stamps; and
transmitting the audio and video packets to devices in the wireless network,
wherein the time stamp includes information indicating reproduction time points of both audio data included in the audio packet and video data included in the video packet.

2. The method of claim 1, wherein the devices are temporally synchronized through a predetermined beacon frame.

3. The method of claim 2, wherein the beacon frame is transmitted from a network management device managing a communication timing of the wireless network.

4. The method of claim 1, further comprising:
receiving a beacon frame;
synchronizing a timer by using the beacon frame; and
providing the time stamp by using the synchronized timer.

5. A synchronization method in a wireless network, the method comprising:
receiving an audio packet;
extracting both audio data and a time stamp indicating an output time point of the audio data from the audio packet; and
outputting the audio data at the time point indicated by the time stamp.

6. The method of claim 5, further comprising decoding the audio data, wherein the outputting comprises outputting the decoded audio data.

7. The method of claim 5, wherein the audio packet is transmitted from a source device temporally synchronized through a predetermined beacon frame.

8. The method of claim 7, wherein the beacon frame is transmitted from a network management device managing a communication timing of the wireless network.

9. The method of claim 5, further comprising:
receiving a beacon frame;
synchronizing a timer by using the beacon frame; and
determining a reproduction time point of the audio data by using the synchronized timer, the reproduction time point of the audio data being indicated by the time stamp.

10. A synchronization method in a wireless network, the method comprising:
receiving a video packet;
extracting both video data and a time stamp indicating an output time point of the video data from the video packet; and
outputting the video data at the time point indicated by the time stamp.

11. The method of claim 10, further comprising decoding the video data, wherein the outputting comprises outputting the decoded video data.

12. The method of claim 10, wherein the video packet is transmitted from a source device temporally synchronized through a predetermined beacon frame.

13. The method of claim 12, wherein the beacon frame is transmitted from a network management device managing a communication timing of the wireless network.

14. The method of claim 10, further comprising:
receiving a beacon frame;
synchronizing a timer by using the beacon frame; and
determining a reproduction time point of the video data by using the synchronized timer, the reproduction time point of the video data being indicated by the time stamp.

15. A source device comprising:
a packet-processing unit which generates audio and video packets including time stamps; and
a wireless communication unit which transmits the audio and video packets to devices in a wireless network,
wherein the time stamp includes information indicating reproduction time points of both audio data included in the audio packet and video data included in the video packet.

16. The source device of claim 15, wherein the devices are temporally synchronized through a predetermined beacon frame.

17. The source device of claim 16, wherein the beacon frame is transmitted from a network management device managing a communication timing of the wireless network.

18. The source device of claim 15, further comprising a time management unit which synchronizes a timer by using a beacon frame received through the wireless communication unit and provides the time stamp by using the synchronized timer.

19. An audio reproduction device comprising:
a wireless communication unit which receives an audio packet;
a packet-processing unit which extracts both audio data and a time stamp indicating an output time point of the audio data from the audio packet; and
a control unit which outputs the audio data at the time point indicated by the time stamp.

20. The audio reproduction device of claim 19, further comprising an audio-decoding unit which decodes the audio data, wherein the control unit outputs the decoded audio data.

21. The audio reproduction device of claim 19, wherein the audio packet is transmitted from a source device temporally synchronized through a predetermined beacon frame.

22. The audio reproduction device of claim 21, wherein the beacon frame is transmitted from a network management device managing a communication timing of the wireless network.

23. The audio reproduction device of claim 19, wherein the control unit synchronizes a timer by using a beacon frame received through the wireless communication unit, and determines a reproduction time point of the audio data by using the synchronized timer, the reproduction time point of the audio data being indicated by the time stamp.

24. A video reproduction device comprising:
a wireless communication unit which receives a video packet;
a packet-processing unit which extracts both video data and a time stamp indicating an output time point of the video data from the video packet; and
a control unit which outputs the video data at the time point indicated by the time stamp.

25. The video reproduction device of claim 24, further comprising a video-decoding unit which decodes the video data, wherein the control unit outputs the decoded video data.

26. The video reproduction device of claim 24, wherein the video packet is transmitted from a source device temporally synchronized through a predetermined beacon frame.

27. The video reproduction device of claim 26, wherein the beacon frame is transmitted from a network management device managing a communication timing of the wireless network.

28. The video reproduction device of claim 24, wherein the control unit synchronizes a timer by using a beacon frame received through the wireless communication unit, and determines a reproduction time point of the video data by using the synchronized timer, the reproduction time point of the video data being indicated by the time stamp.
